(19) United States
(12) Patent Application Publication
(10) Pub. No.: US 2016/0011825 A1
(43) Pub. Date: Jan. 14, 2016

(54) IMAGE RECORDING SYSTEM, IMAGE RECORDING DEVICE, INFORMATION PROCESSING DEVICE, AND IMAGE RECORDING CONTROL METHOD

(71) Applicants: Yoichi Ito, Tokyo (JP); Hiroshi Noda, Kanagawa (JP); Yoshinori Uchino, Kanagawa (JP)

(72) Inventors: Yoichi Ito, Tokyo (JP); Hiroshi Noda, Kanagawa (JP); Yoshinori Uchino, Kanagawa (JP)

(73) Assignee: RICOH COMPANY, LTD., Tokyo (JP)

(21) Appl. No.: 14/744,255

(22) Filed: Jun. 19, 2015

(30) Foreign Application Priority Data
Jul. 8, 2014 (JP) 2014-140223

(51) Int. Cl. G06F 3/12

(52) U.S. Cl. CPC G06F 3/1211; G06F 3/1242; G06F 3/1256

(57) ABSTRACT

An image recording system includes an image recording device that records an image on a to-be-recorded medium while being moved on a surface of the to-be-recorded medium, and an information processing device communicable with the image recording device. The information processing device obtains a relative position and a posture of the image recording device with respect to the to-be-recorded medium, generates recording operation guidance information that guides the image recording device to record the image on the to-be-recorded medium based on image data, setting information for the image data, and the relative position and the posture of the image recording device, the recording operation guidance information indicating an arrangement position of the image recording device with respect to the to-be-recorded medium and a movement direction of the image recording device, and outputs the recording operation guidance information.

### CROSS-REFERENCE TO RELATED APPLICATIONS

This patent application is based on and claims priority pursuant to 35 U.S.C. §119(a) to Japanese Patent Application No. 2014-140223, filed on Jul. 8, 2014, in the Japan Patent Office, the entire disclosure of which is hereby incorporated by reference herein.

### BACKGROUND

1. Technical Field

The present invention relates to an image recording system, image recording device, information processing device, and an image recording control method.

2. Description of the Related Art

With the widespread use of information terminals that are small and mobile, such as notebook computers and smart devices, the demand for size reduction and enhanced portability of image recording devices, such as printers, increases.

The mobile printer has been available, which records and outputs an image on a to-be-recorded medium, as it is manually moved on such to-be-recorded medium. To record an image that the user intends with a printer that records the image as it is manually moved, it is important to appropriately align the printer and the to-be-recorded medium as well as to appropriately move the printer.

That is, even a very small angular deviation when the printer is placed at an image recording start position on the to-be-recorded medium causes a printed image to be tilted. For example, assume the case where the printer, deviated 3 degrees, is placed on the to-be-recorded medium. In that case, when the printer is moved 297 mm (the length of the long side of an A4 sheet), the printer is deviated 15.6 mm.

In the case of recording a variably-magnified image, how the image will be recorded on the recording medium is difficult to predict, and it is thus difficult to determine the image recording start position and the movement direction.

Further, in the case of recording an image over an already-recorded image, it is very difficult to align the already-recorded image and the newly recorded image. This difficulty becomes even more severe when the newly recorded image is variably magnified and recorded.

In the case of recording an image while leaving a blank portion, it is difficult to determine the image recording start position. For example, assume the case where printing starts at the upper left-hand corner of a to-be-recorded medium. Even a preview of A5 size characters on a computer does not enable the user to recognize after how many millimeters the recording of an image starts. In this case, even when the user recognizes after how many millimeters the recording of an image starts, it is still difficult to align that image and the to-be-recorded medium in units of millimeters and to place the printer at the image recording start position.

From the above, an image recording system in which an image is recorded on an image recording device that is manually moved has difficulty in determining the image recording start position on a to-be-recorded medium and the movement direction. It is also difficult to place the image recording device at the image recording start position and to operate the image recording device. Even in the case where an image in accordance with the position of the image recording device is recorded, if the movement direction of the image recording device is deviated, an intended image is not recorded by one movement, resulting in poor image quality and operability.

### SUMMARY

Example embodiments of the present invention include an image recording system includes an image recording device that records an image on a to-be-recorded medium while being moved on a surface of the to-be-recorded medium, and an information processing device communicable with the image recording device. The information processing device obtains a relative position and a posture of the image recording device with respect to the to-be-recorded medium, generates recording operation guidance information that guides the image recording device to record the image on the to-be-recorded medium based on image data, setting information for the image data, and the relative position and the posture of the image recording device, the recording operation guidance information indicating an arrangement position of the image recording device with respect to the to-be-recorded medium and a movement direction of the image recording device, and outputs the recording operation guidance information.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is an illustration of an image recording system according to an embodiment of the present invention;

FIG. 2 is a block diagram of a mobile printer of FIG. 1;

FIG. 3 is a functional block diagram of the mobile printer of FIG. 2;

FIG. 4 is a block diagram of a mobile information processing terminal of FIG. 1;

FIG. 5 is a functional block diagram of the mobile information processing terminal;

FIGS. 6A to 6C are illustrations of an example where the posture of the mobile printer is obtained using three sides;

FIGS. 7A to 7C are illustrations of an example where the posture of the mobile printer is obtained using four sides;

FIG. 8 is an illustration of depth correction in detecting the posture of the mobile printer using four sides;

FIG. 9 is a diagram illustrating an example of display that displays a setting information change window on a recording environment image;

FIG. 10 is a diagram illustrating an example of display that displays a detailed setting change window on the recording environment image;

FIG. 11 is a diagram of an operation of changing the horizontal magnification in setting information using a key operation;

FIG. 12 is a diagram of an operation of changing the scale in the setting information using a key operation;

FIG. 13 is a flowchart illustrating an image recording operation of the mobile information processing terminal;

FIG. 14 is a flowchart illustrating an operation of determining the position of a preview image;

FIG. 15 is a flowchart illustrating a preview operation during recording;

FIG. 16 is a diagram illustrating exemplary display of an unrecorded image area with respect to a preview image; and

FIG. 17 is a flowchart illustrating an image recording operation of the mobile printer.

The accompanying drawings are intended to depict example embodiments of the present invention and should not be interpreted to limit the scope thereof The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Hereinafter, a preferred exemplary embodiment of the present invention will be described in detail with reference to the attached drawings. Since the following embodiment is a preferred exemplary embodiment of the present invention, various technically preferred limitations are added thereto. However, the scope of the present invention is not construed to be limited by the following description, and not all configurations described in the embodiment are essential elements of the present invention.

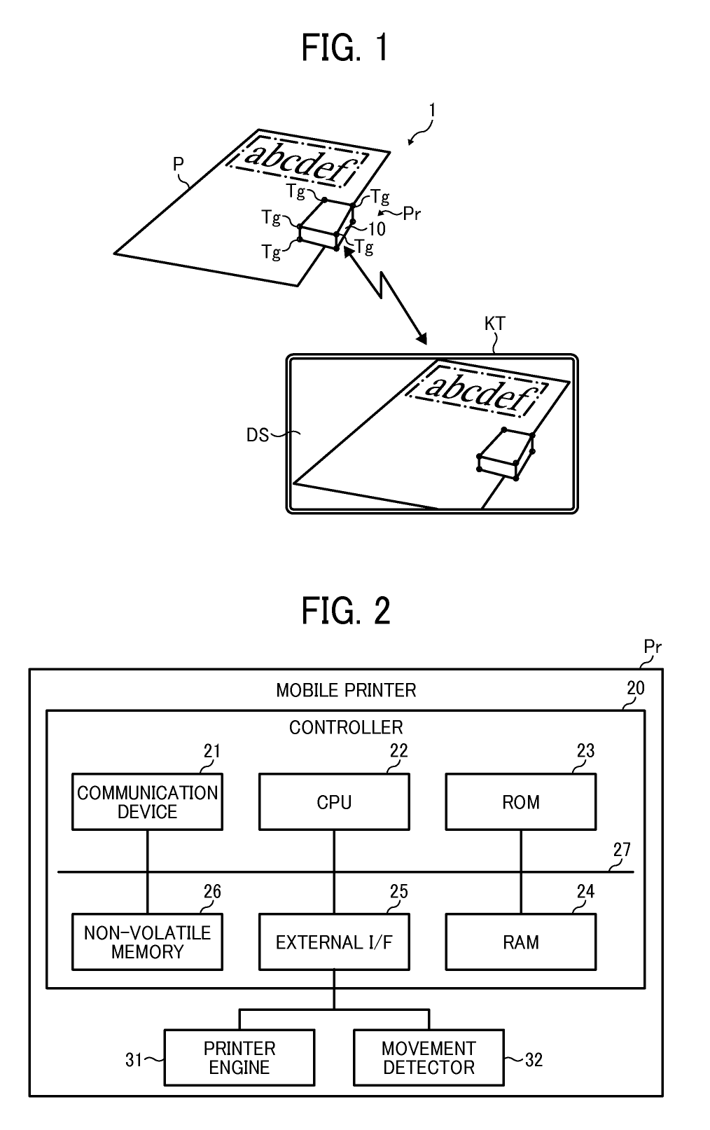

FIGS. 1 to 17 are diagrams illustrating an image recording system and an image recording method according to an embodiment of the present invention. FIG. 1 is a diagram of an image recording system 1 to which the image recording system and the image recording method according to the embodiment of the present invention are applied.

Referring to FIG. 1, the image recording system 1 includes a mobile printer Pr and a mobile information processing terminal KT, and the mobile printer Pr and the mobile information processing terminal KT communicate with each other wirelessly.

The image recording system 1 records an image in response to a user's manual operation of the mobile printer Pr to move and operate on a recording surface of a to-be-recorded medium. In this example, the term “recording” is used to indicate printing performed by the mobile printer Pr. Examples of the to-be-recorded medium include a planar-shaped to-be-recorded medium such as a sheet of paper or a film, and a three-dimensional to-be-recorded medium such as a folded carton. Hereinafter, the to-be-recorded medium will be simply referred to as paper P. Communication between the mobile printer Pr and the mobile information processing terminal KT need not necessarily be performed wirelessly, and may be performed by wire. Since the image recording system 1 records an image in response to the user's manual operation of the mobile printer Pr to move on the recording surface of the paper P, wireless communication is more suitable.

The mobile printer (image recording device) Pr has target portions (marks) Tg at the main corners of a box-shaped casing 10. As will be described later, the target portions Tg are used to detect, by the mobile information processing terminal KT, the relative position and posture state of the mobile printer Pr with respect to the paper P, and the recording surface of the paper P.

Since the mobile printer Pr moves on the paper P and records an image in response to the user's manual operation, a movement assisting mechanism suitable for moving the mobile printer Pr on the paper P in an arbitrary direction, such as ball feet capable of rotating in any direction, are placed at the lower four corners of the casing 10.

FIG. 2 illustrates the hardware configuration of the mobile printer Pr. The mobile printer Pr includes a controller 20, a printer engine 31, a movement detector 32 and so forth.

The controller 20 includes a communication device 21, a central processing unit (CPU) 22, a read-only memory (ROM) 23, a random-access memory (RAM) 24, an external interface (UF) 25, a non-volatile memory 26, and so forth. The elements 21 to 26 of the controller 20 are connected by a bus 27.

The ROM 23 stores a basic program for operating the mobile printer Pr, an image recording program for causing the mobile printer Pr to execute an image recording operation as described below, and system data.

The RAM 24 is used as, for example, a work memory for the CPU 22, and stores various types of data.

The CPU 22 controls the elements of the mobile printer Pr on the basis of the programs stored in the ROM 23 to execute a basic operation as the mobile printer Pr, and to perform image recording operation according to the embodiment of the present invention.

The communication device 21, which may be implemented by a communication circuit such as a network interface circuit, wirelessly communicates with the mobile information processing terminal KT by performing near infrared communication such as Infrared Data Association (IrDA), or short-distance wireless communication such as Bluetooth (registered trademark), near field communication (NFC), or radio frequency identification (RFID).

An electrically erasable programmable read-only memory (EEPROM), for example, is used as the non-volatile memory 26, and the non-volatile memory 26 keeps storing contents even when the power of the mobile printer Pr is turned off. The non-volatile memory 26 stores, under control of the CPU 22, various types of data necessary for operating as the mobile printer Pr, and data necessary for executing the image recording operation according to the embodiment of the present invention, and the stored data is read from the non-volatile memory 26 under control of the CPU 22. The non-volatile memory 26 stores, for example, print image data and setting information sent from the mobile information processing terminal KT, movement control information for the mobile printer Pr, a movement detection value from the movement detector 32, and so forth.

The external I/F 25 is connected to the printer engine 31 and the movement detector 32, and the external I/F 25 exchanges data between the printer engine 31 and the CPU 22 and between the movement detector 32 and the CPU 22.

A printer engine using an arbitrary image recording system, such as an inkjet printer engine, is used as the printer engine 31. In the case of inkjet printing, the printer engine 31 has a recording head with a plurality of nozzles arranged in a certain number of rows over a certain length, a nozzle driving unit that individually drives and operates the nozzles of the recording head on the basis of image data, and so forth. Particularly in the printer engine 31, the timing of driving, by the nozzle driving unit, each of the nozzles of the recording head is controlled on the basis of a drive control signal from the CPU 22. The printer engine 31 records an image in accordance with image data on the recording surface of the paper P in accordance with the driving timing based on the drive control signal from the CPU 22.

The movement detector 32 detects the amount and direction of movement of the mobile printer Pr, and outputs a movement detection signal indicating the amount and direction of movement to the CPU 22 via the external I/F 25. More specifically, a detection light is emitted to the recording surface of the paper P facing the bottom face of the mobile printer Pr, or to a flat receptacle on which the paper P is held. The movement detector 32 is provided with a reflection optical sensor that detects reflected light of that detection light. Alternatively, the movement detector 32 detects the amount and direction of movement of the mobile printer Pr by detecting, for example, the amount and direction of rotation of the balls of the above-mentioned movement assisting mechanism.

Note that the movement detector 32 is not limited to that provided in the mobile printer Pr, and may be provided in the mobile information processing terminal KT, for example. Alternatively, the movement detector 32 may be provided separate from the mobile printer Pr or the mobile information processing terminal KT, and may be provided at a surrounding position distant by a certain amount from the mobile printer Pr and the paper P serving as a recording target. In this case, the movement detector 32 may detect the position of the mobile printer Pr by using, for example, trigonometry utilizing ultrasonic waves or the like.

The CPU 22 sends, from the communication device 21 to the mobile information processing terminal KT, a movement detection signal detected by the movement detector 32 as it is or after converting the signal to a movement amount signal and a movement direction signal of the mobile printer Pr.

In the following, the mobile printer Pr is implemented as an image recording device that performs image recording operation according to an image recording program of the embodiment of the present invention. The image recording program may be installed onto the ROM 23 or the like, from a computer-readable recording medium such as a ROM, an EEPROM, an EPROM, a flash memory, a flexible disk, a compact-disc read-only memory (CD-ROM), a compact disc rewritable (CD-RW), a digital versatile disk (DVD), a secure digital (SD) card, or a magneto-optical disc (MO). The image recording program is a computer-executable program written in a legacy programming language, an object-oriented programming language, or the like, such as an assembler, C, C++, C#, or Java (registered trademark), and can be stored in the above-described recording medium and distributed.

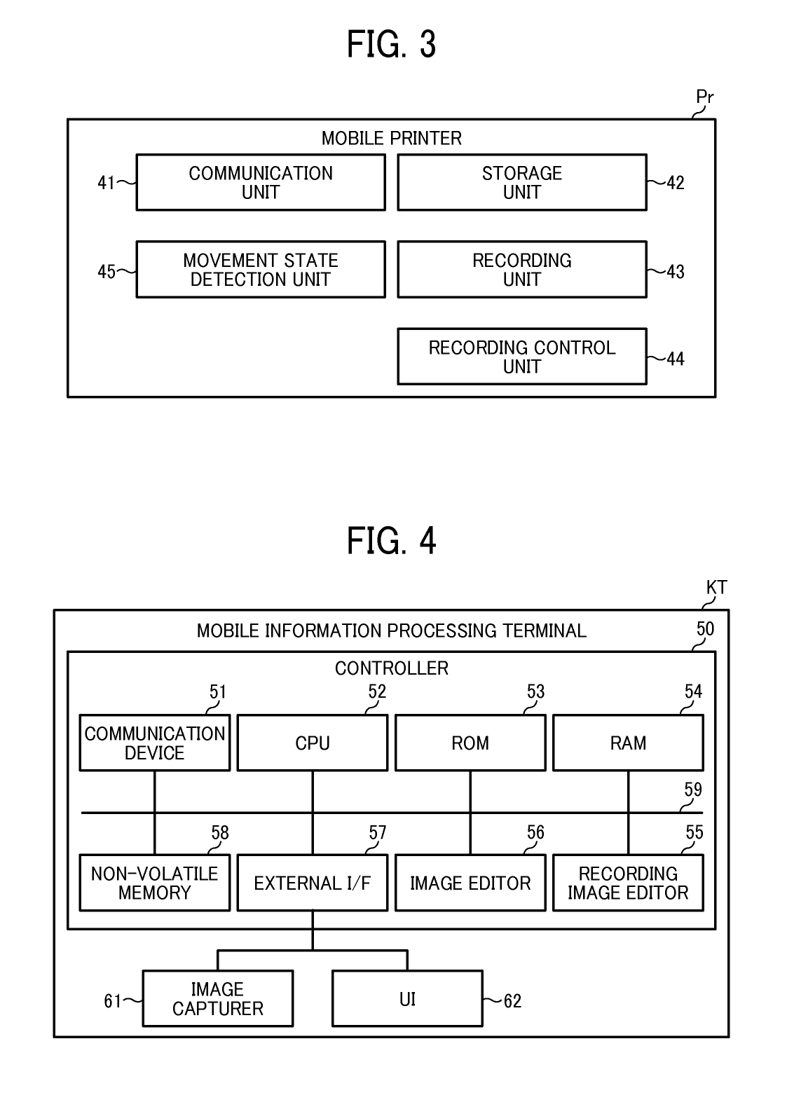

More specifically, the CPU 22 of the mobile printer Pr controls hardware illustrated in FIG. 2 according to the image recording program to have a functional configuration illustrated in FIG. 3. The mobile printer Pr includes a communication unit 41, a storage unit 42, a recording unit 43, a recording control unit 44, and a movement state detection unit 45.

The communication unit 41, which may be implemented by the communication device 21, exchanges data and signals by communicating with the mobile information processing terminal KT.

The storage unit 42, which may be implemented by the RAM 24 or the non-volatile memory 26, stores print image data and setting information sent from the mobile information processing terminal KT, movement control information for the mobile printer Pr, a movement detection value received from the movement state detection unit 45, etc.

The recording unit (image recorder) 43, which is implemented by the printer engine 31, records and outputs an image on the paper P on the basis of the print image data and the setting information in the storage unit 42.

The recording control unit 44 may be implemented by the CPU 22. The recording control unit 44 controls image recording performed by the recording unit 43, on the basis of the drive control signal and recording image data received by the communication unit 41 from the mobile information processing terminal KT, and records a recording image in accordance with the position and posture of the mobile printer Pr.

The movement state detection unit 45, which may be implemented by the movement detector 32, detects the amount and direction of movement, which serve as the movement state, of the mobile printer Pr, and transmits a movement detection signal to the mobile information processing terminal KT via the communication unit 41.

Now, a hardware structure of the mobile information processing terminal KT is explained, referring to FIG. 4. The mobile information processing terminal KT may be implemented by any portable information processing terminal such as a smart phone, a tablet, or a notebook computer. The mobile information processing terminal KT includes a controller 50, an image capturer 61, a user interface (UI) 62, and so forth, as illustrated in FIG. 4.

The image capturer 61 includes, for example, a mechanism including a lens and auto-focus, an imaging sensor such as a charge coupled device (CCD) or a complementary metal oxide semiconductor (CMOS), and an image processing circuit. The image capturer 60 captures a moving image, and outputs the captured moving image as image data to the controller 50.

Particularly in the embodiment, the image capturer 61 captures an image of the paper P, which is an image recording target, and the mobile printer Pr placed on the paper P as a recording environment image, and outputs the recording environment image as recording environment image data to the controller 50.

The UI 62 includes hardware keys, a display DS illustrated in FIG. 1, and other user interfaces. The display DS has a touch sensor that detects a touch operation on a display screen. The UI 62 displays display data sent from the controller 50 on the display DS. The display data is, as will be described later, an image captured by the image capturer 61, particularly a recording environment image, a preview image of a recording image, movement operation guidance information, function keys, and information entry boxes for the mobile printer Pr, which are generated by the controller 50 in image recording, and so forth.

The UI 62 obtains the details of touch operations on the function keys, a preview image, and so forth, detected by the touch sensor, the details of input of numerals and information entered in the information entry boxes, and the details of operation of hardware keys, and outputs the obtained details to the controller 50.

The controller 50 includes a communication device 51, a CPU 52, a ROM 53, a RAM 54, a recording image editor 55, an image editor 56, an external I/F 57, a non-volatile memory 58, and so forth, and the elements 51 to 58 are connected by a bus 59.

The communication device 51, which may be implemented by a network interface circuit, wirelessly communicates with the mobile printer Pr using the above-mentioned wireless communication system used by the mobile printer Pr.

The ROM 53 stores a basic program for the mobile information processing terminal KT, an image recording program that causes the terminal KT to execute an image recording program according to the embodiment of the present invention, and system data.

The RAM 54 is used as, for example, a work memory for the CPU 52, and stores various types of data.

The CPU 52 controls the elements of the mobile information processing terminal KT according to the programs stored in the ROM 53 to execute a basic function as the mobile information processing terminal KT, and to perform image recording operation according to the embodiment of the present invention.

The recording image editor 55 is implemented by an application specific integrated circuit (ASIC), for example, and, under control of the CPU 52, generates a recording image to be recorded and output by the mobile printer Pr or performs editing on the recording image.

That is, the recording image editor 55 generates a recording image of a document, an image, or the like to be recorded and output by the mobile printer Pr by using an application installed in the later-described non-volatile memory 58. In addition, in response to inputting, from the UI 62, for example, of setting information in recording and outputting the recording image by the mobile printer Pr, the recording image editor 55 reflects the setting information, and generates recording image data in a format suitable for the mobile printer Pr to analyze, record, and output the recording image. Further, in response to a change operation from the later-described UI 62, such as enlarging or reducing the size of the recording image, moving or transforming the recording image, or changing the font, the recording image editor 55 edits the recording image in accordance with the change operation, and re-generates recording image data.

The recording image editor 55 causes the communication device 51 to transmit, out of the generated recording image data, recording image data in accordance with the position of the mobile printer Pr to the mobile printer Pr.

The image editor 56 may be implemented by an ASIC, for example, and performs various types of image editing under control of the CPU 52. The image editor 56 performs image editing operations such as an image editing operation for displaying an image captured by the image capturer 61, particularly a recording environment image, on the display DS, an image conversion operation for converting a recording image generated by the recording image editor 55 to a preview image, and an image operation for generating a display image by combining operation guidance information for moving and operating the mobile printer Pr in causing the mobile printer Pr to record and output the recording image reflecting the setting information, and the preview image with the recording environment image.

The external I/F 57 is connected to the image capturer 61 and the UI 62, and exchanges data and signals between the image capturer 61 and the CPU 52 and between the UI 62 and the CPU 52.

The non-volatile memory 58 may be implemented by an EEPROM, a solid state drive (SSD), or the like. The non-volatile memory 58 keeps stored contents even when the power of the mobile information processing terminal KT is turned off. The non-volatile memory 58 stores, under control of the CPU 52, various types of data necessary for operating as the mobile information processing terminal KT, and data necessary for performing the image recording operation according to the embodiment of the present invention, and the stored data is read from the non-volatile memory 58 under control of the CPU 52. The non-volatile memory 58 stores, for example, a recording image, setting information, recording image data, a captured image (particularly a recording environment image), a preview image, a display image after combining information with an image, operation guidance information, and a movement detection value sent from the mobile printer Pr.

The mobile information processing terminal KT is implemented as a mobile information processing terminal that performs image recording operation according to the image recording program of the embodiment of the present invention. The image recording program may be installed onto the ROM 53 or the like, from a computer-readable recording medium such as a ROM, an EEPROM, an EPROM, a flash memory, a flexible disk, a CD-ROM, a CD-RW, a DVD, an SD card, or an MO. The image recording program is a computer-executable program written in a legacy programming language, an object-oriented programming language, or the like, such as an assembler, C, C++, C#, or Java (registered trademark), and can be stored in the above-described recording medium and distributed.

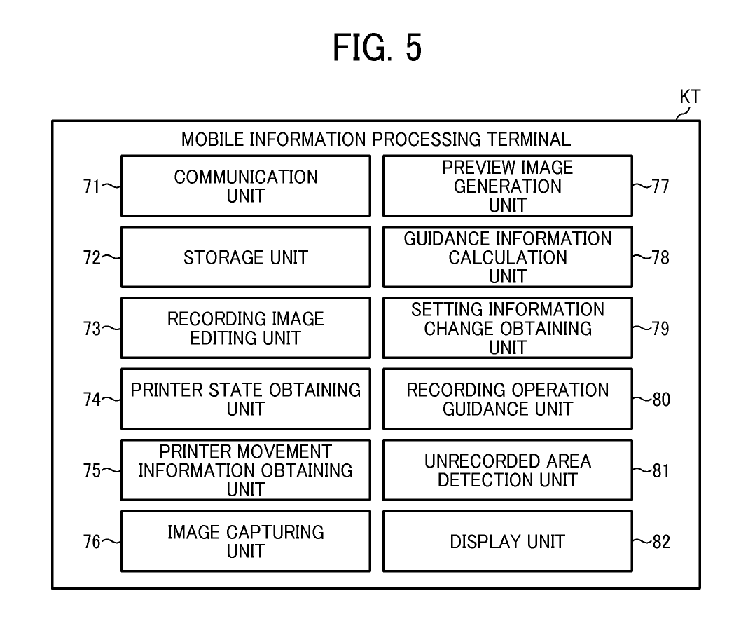

More specifically, the CPU 52 of the mobile information processing terminal KT controls hardware illustrated in FIG. 4 according to the image recording program to have a functional configuration illustrated in FIG. 5. The mobile information processing terminal

KT includes a communication unit 71, a storage unit 72, a recording image editing unit 73, a printer state obtaining unit 74, a printer movement information obtaining unit 75, an image capturing unit 76, a preview image generation unit 77, a guidance information calculation unit 78, a setting information change obtaining unit 79, a recording operation guidance unit 80, an unrecorded area detection unit 81, and a display unit 82.

The display unit (reporter, display, display control) 82 is configured by the display DS of the UI 62, the external I/F 57, the CPU 52, and so forth. The display unit 82 particularly displays a recording environment image Kg captured by the image capturer 61, a preview image Pg of a recording image, movement operation guidance information, function keys, and information entry boxes for the mobile printer Pr, which are generated by the controller 50 in image recording, and so forth. The display unit 82 also has a touch operation detector function, which may be implemented by the touch sensor that detects a touch operation on a display image on the display DS of the UI 62.

The communication unit 71, which is implemented by the communication device 51, wirelessly communicates with the mobile printer Pr.

The storage unit 72, which is implemented by the non-volatile memory 58 and the RAM 54, stores recording image data, display data, and other data.

The recording image editing unit 73, which is implemetned by the recording image editor 55, generates a recording image of a document, an image, or the like to be recorded and output by the mobile printer Pr. In addition, in response to a change of setting information in recording and outputting the recording image by the mobile printer Pr, the recording image editing unit 73 reflects the setting information, and generates recording image data in a format suitable for the mobile printer Pr to analyze, record, and output the recording image. Further, in response to obtaining, by the later-described setting information change obtaining unit 79, of a change, such as enlarging or reducing the size of the recording image, moving or transforming the recording image, or changing the font, the recording image editing unit 73 edits the recording image in accordance with the change, and generates recording image data. The recording image editing unit 73 also outputs the generated recording image data to the mobile printer Pr in accordance with the relative position and posture of the mobile printer Pr with respect to the paper P, which will be described later, and executes a recording control operation of recording and outputting an image in accordance with the position and posture of the mobile printer Pr on the paper P. Therefore, the recording control unit 44 of the mobile printer Pr and the recording image editing unit 73 function together as a recording control.

The image capturing unit 76, which is implemented by the image capturer 61, captures an image, particularly a moving image of the paper P, which is an image recording target, and the mobile printer Pr placed on the paper P as a recording environment image. The image capturing unit 76 also has an auto-focus function and is capable of capturing an image while focusing on the target portions Tg of the mobile printer Pr.

The printer state obtaining unit 74 is implemented by the image capturer 61, the CPU 52, and so forth. The printer state obtaining unit 74 extracts a video image of the target portions Tg from the captured video image of the mobile printer Pr, captured by the image capturer 61, and, on the basis of the video image of the target portions Tg, detects the relative position of the mobile printer Pr with respect to the paper P, the posture state of the mobile printer Pr, and the recording surface of the paper P.

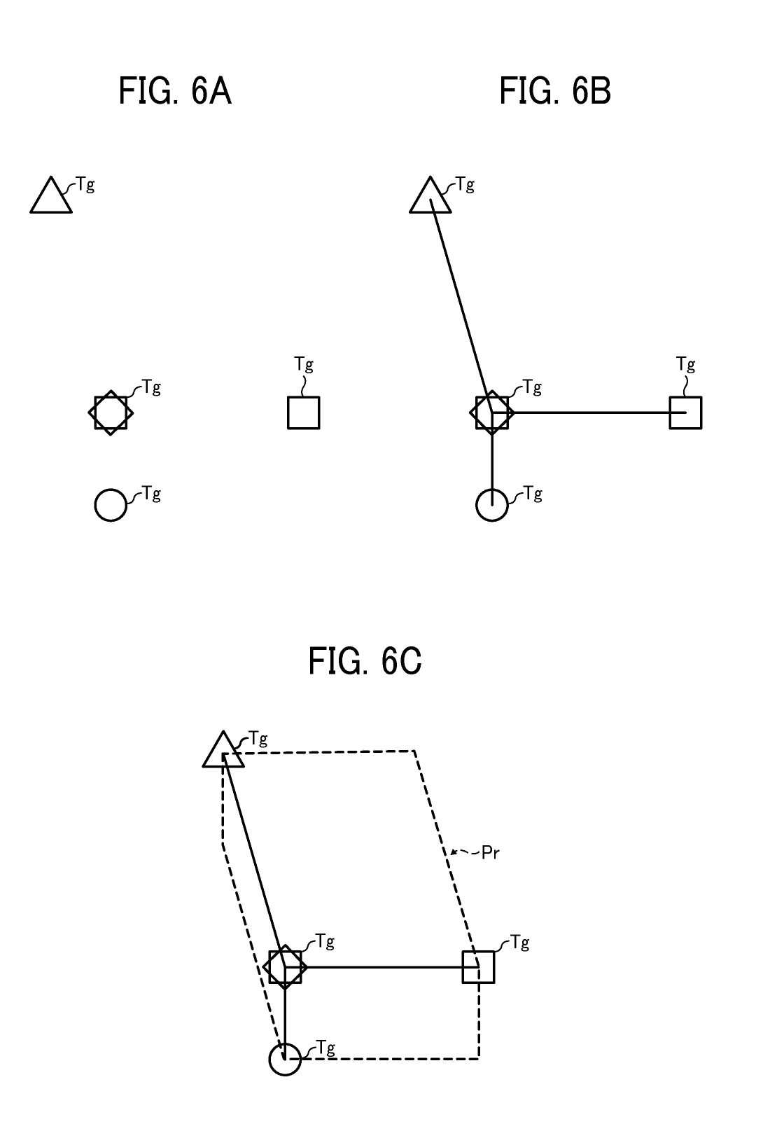

For example, the printer state obtaining unit 74 extracts, for example, at least four target portions Tg that can define three sides that are not parallel with one another, as illustrated in FIG. 6A, and defines three sides that are not parallel with one another, as illustrated in FIG. 6B. In this case, it is preferable that the target portions Tg be those that can confirm that they are target portions Tg different from one another, as illustrated in FIGS. 6A to 6B. After defining three sides that are not parallel with one another, the printer state obtaining unit 74 calculates the posture of the mobile printer Pr, as illustrated in FIG. 6C.

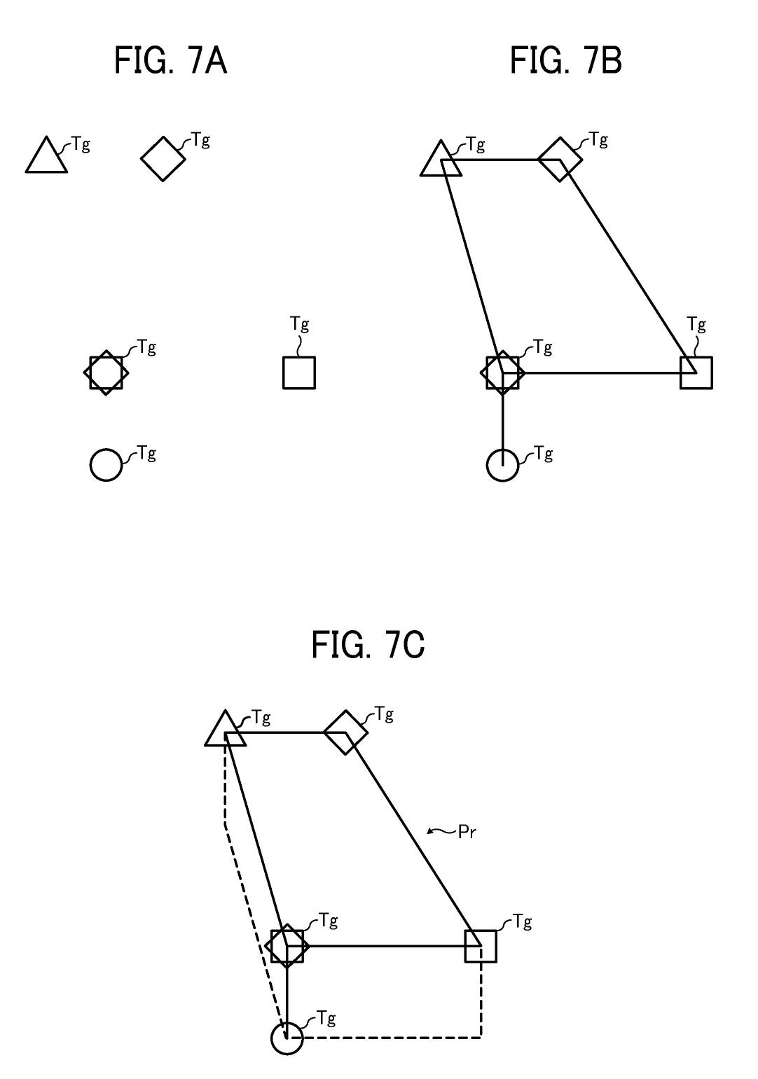

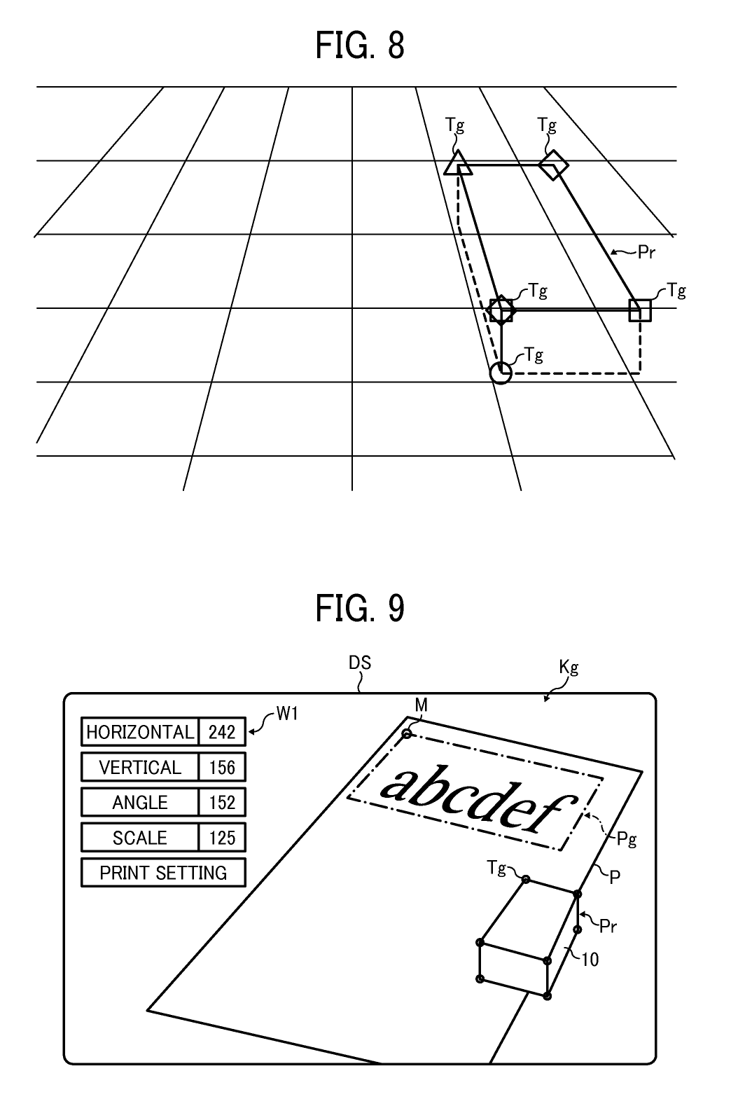

Alternatively, the printer state obtaining unit 74 extracts, for example, at least four target portions Tg that can define three sides that are not parallel with one another, and the fifth target portion Tg that can define another side that may be parallel with one of these three sides, as illustrated in FIG. 7A. As illustrated in FIG. 7B, the printer state obtaining unit 74 defines four sides including three sides that are not parallel with one another, and another side that may be parallel with one of these three sides. On the basis of the four sides, the printer state obtaining unit 74 calculates the posture of the mobile printer Pr, as illustrated in FIG. 7C. In the case of using these four sides, as illustrated in FIG. 8, depth correction based on image capturing can be performed by defining the four sides, and the more accurate posture of the mobile printer Pr can be obtained, compared with the case of using three sides.

Alternatively, the printer state obtaining unit 74 may extract one target portion Tg that can define preset three sides, instead of extracting a plurality of target portions Tg, and may obtain the posture of the mobile printer Pr. In this case, instead of having a fixed target portion Tg as a target portion Tg to be extracted, the target portions Tg are made distinguishable, and extracting one of these target portions T eventually enables defining of three sides. In doing so, even when the user is holding the mobile printer Pr in his/her hand, extracting a target portion Tg that is not covered with the hand may enable defining of three sides, which may result in obtaining of the posture of the mobile printer Pr.

That is, the greater the number of target portions Tg to be extracted and the wider the range, the more accurate posture of the mobile printer Pr the printer state obtaining unit 74 can obtain. For each printer Pr, the number of target portions Tg to be extracted and the range can be arbitrarily set.

Further, the printer state obtaining unit 74 captures an image of the paper P, which is an image recording target, as well as the mobile printer Pr. After spatially defining the posture of the mobile printer Pr, the printer state obtaining unit 74 assumes that the mobile printer Pr is placed on the recording surface of the paper P, and obtains the relative position of the mobile printer Pr with respect to the sheet P, and the recording surface of the paper P.

The printer state obtaining unit 74 also calculates the focal point of the recording surface of the paper P in response to focusing the image capturing unit 76 on a plurality of target portions Tg of the mobile printer Pr.

The image capturing unit 76 and the printer state obtaining unit 74 function together as an image recording device state obtaining unit.

The printer movement information obtaining unit 75 is implemented by the communication unit 71, the CPU 52, and so forth. The communication unit 71 obtains the amount and direction of movement of the mobile printer Pr on the basis of a movement detection value received by the communication unit 71 from the mobile printer Pr.

The movement state detection unit 45 of the mobile printer Pr and the printer movement information obtaining unit 75 function together as a movement state obtaining unit that obtains the movement state of the mobile printer Pr, which is an image recording device.

The preview image generation unit (preview generator, preview image adjuster) 77, which is implemented by the image editor 56, generates a preview image for displaying, on the display DS, a preview of a recording image generated by the recording image editing unit 73. The preview image generation unit 77 also performs a preview image adjusting operation of adjusting the preview image to an image of the paper P in a recording environment image displayed on the display DS.

The guidance information calculation unit (guidance information calculator) 78, which is implemented by the CPU 52, at least calculates recording operation information including the arrangement position such as the position at which an image is recorded on the paper P by the mobile printer Pr, and the movement operation direction of the mobile printer Pr. The guidance information calculation unit 78 calculates recording operation guidance information including the arrangement position of the mobile printer Pr with respect to the paper P, and the movement operation direction of the mobile printer Pr, at least in order for the mobile printer Pr to record a recording image on the paper P, on the basis of image data of the recording image, the relative position of the mobile printer Pr with respect to the paper P, the posture state of the mobile printer Pr, and setting information for image recording.

The setting information change obtaining unit (setting information change acceptor, change control) 79 is implemented by the UI 62, and obtains a change in setting information that is made by the user on the recording image. The setting information change obtaining unit 79 displays, for example, on the display DS, a setting information change window W1 superimposed on the recording environment image Kg displaying the preview image Pg, as illustrated in FIG. 9. Referring to FIG. 9, the setting information change window W1 displays a numeral representing the horizontal length of the recording image in a “horizontal” item, a numeral representing the vertical length of the recording image in a “vertical” item, the angle of the recording image in an “angle” item, the scale of the recording image at the time of recording in a “scale” item, and a print setting item for setting the font, color, and so forth.

The setting information change obtaining unit 79 can change the above-mentioned items by using various changing methods, and obtains the changes. For example, in response to a touch operation performed to change the position, size, gradient, and/or magnification of the preview image Pg, the setting information change obtaining unit 79 obtains the change operation as a change operation for the setting information. For example, in response to selecting the preview image Pg by long touching (long tapping) and moving the preview image Pg without releasing the touch, the setting information change obtaining unit 79 obtains this operation as a change of the recording position of the recording image. For example, in response to rotation of the preview image Pg by multi-touching (two-point touch) without changing the distance between the two points, the setting information change obtaining unit 79 obtains this operation as a change of the angle of the recording image. Further, in response to pinching out the preview image Pg, the setting information change obtaining unit 79 obtains this operation as enlargement of the recording image; and, in response to pinching in of the preview image Pg, the setting information change obtaining unit 79 obtains this operation as size reduction of the preview image Pg.

In response to direct entry of a numeral to each item on the setting information change window W1 illustrated in FIG. 9, the setting information change obtaining unit 79 obtains this entry as a change of the setting of that item. In this case, basically, the current position of the mobile printer Pr serves as a reference of the position of the recording image, and the horizontal and vertical lengths, angle, and scale are determined and obtained. However, the reference of the position of the recording image is not limited to the position of the mobile printer Pr, and the reference may be an image reference, for example.

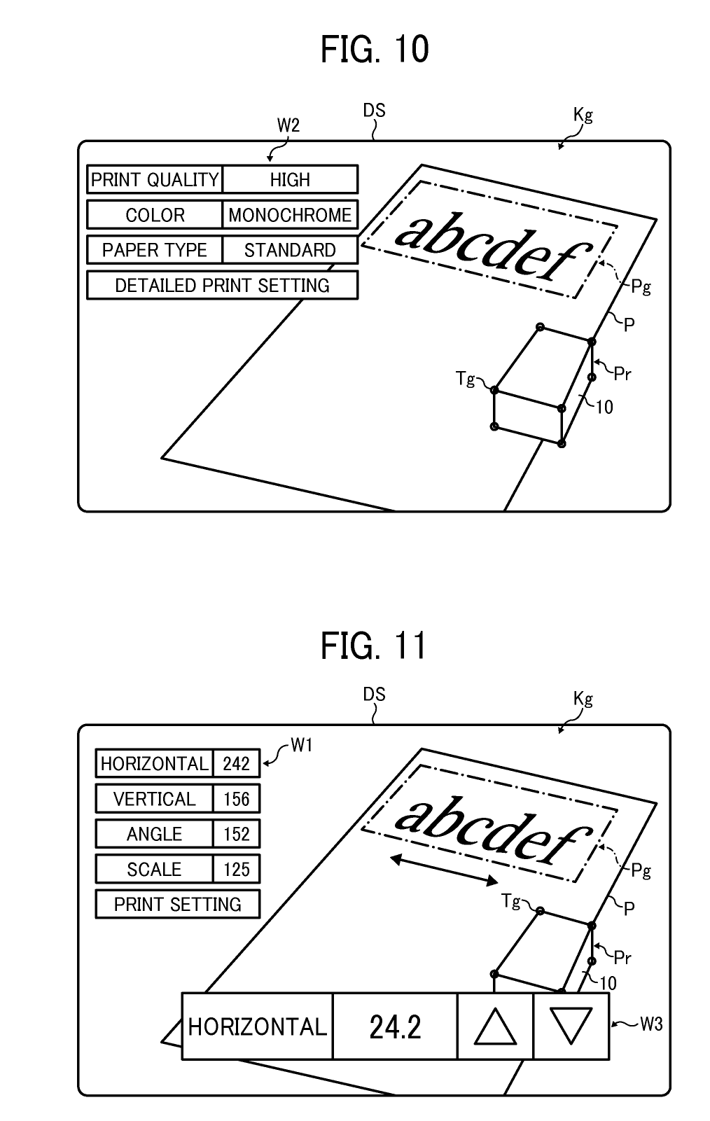

For setting information other than the horizontal and vertical lengths, angle, and scale, in response to touching the “print setting” item, the setting information change obtaining unit 79 displays, for example, a detailed setting change window W2 such as that illustrated in FIG. 10, and a detailed setting change can thus be made. On the detailed setting change window W2 illustrated in FIG. 10, the print quality, the color, and the type of paper can be set.

Note that the method of inputting a change of the setting information is not limited to that described above, and various methods can be used, such as changing the numerals with upward and downward keys, changing the numerals by moving a bar, and changing the numerals by rotating bars indicating the angle within a circle, as in the hands of a clock.

Although the setting information is indicated by an item and a numeral on the setting information change window W1 in FIG. 9, displaying the details of the setting information is not limited to that described above, and various display methods can be used, such as displaying the setting information using an arrow or a symbol such as a magnifying glass, instead of characters. Regarding the display method, the user may be allowed to select between character-based display or symbol-based display; and, regarding the entry method, the user may be allowed to arbitrarily select one of the above-described methods.

For example, when the user wants to enlarge or reduce the horizontal length in FIG. 9, the user touches the “horizontal” item on the setting information change window W1. In response to touching the “horizontal” item, as illustrated in FIG. 11, the setting information change obtaining unit 79 enlarges and displays a horizontal setting change window W3. In response to direct entry of a new numeral or touching the upward/downward arrow keys on the setting change window W3, the setting information change obtaining unit 79 obtains the operation details as a change in the horizontal length in the setting information. Note that the enlargement and size reduction directions are indicated by the two arrows in FIG. 11.

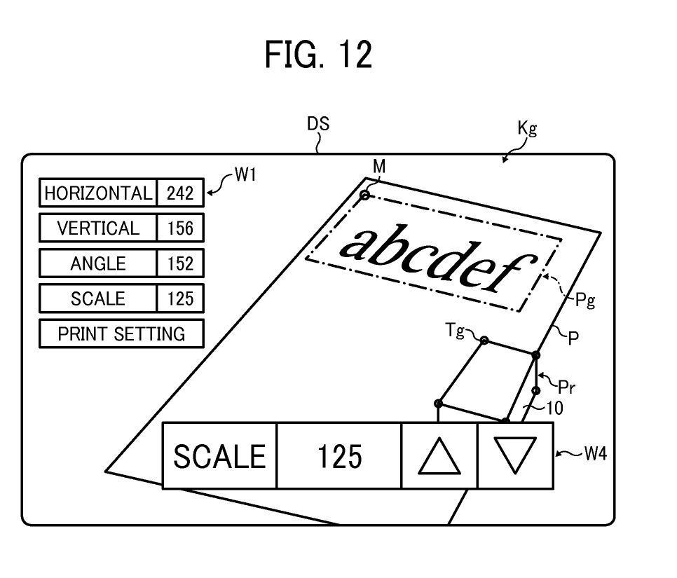

For example, when the user wants to change the scale in FIG. 9, the user touches the “scale” item on the setting information change window W1. In response to touching the “scale” item, as illustrated in FIG. 12, the setting information change obtaining unit 79 enlarges and displays a scale setting change window W4. In response to direct entry of a new numeral or touching the upward/downward arrow keys on the setting change window W4, the setting information change obtaining unit 79 obtains the operation details as a change in the scale in the setting information. Note that a scale reference mark M serving as a scale reference is displayed on the preview image Pg in FIG. 12. The user may be allowed to change the scale reference mark M to an arbitrary corner of the preview image Pg.

Since a change reference of the recording image (a change reference of the setting information) is an absolute position in the case where the reference is the mobile printer Pr, the value is not changed; however, in the case of an image reference, the reference also moves after the movement, and thus the value is reset to “0”. Allowing the user to arbitrarily select the mobile printer Pr or the image as a reference can improve the operability.

Further, in changing the setting information, the setting information change obtaining unit 79 may store the setting information before the change and the setting information at various timings during the change, which allows the setting information to be changed back to arbitrary setting information. In doing so, the operability in changing the setting information can be improved.

When the setting information change obtaining unit 79 accepts a change of the setting information, the guidance information calculation unit 78 re-calculates the recording operation guidance information, the preview image generation unit 77 re-generates the preview image Pg, and the preview image generation unit 77 performs image adjustment of adjusting the preview image Pg to the paper P in the recording environment image Kg.

The recording operation guidance unit (reporter) 80 is implemented by the CPU 52, the image editor 56, the UI 62, and so forth, and outputs guidance information and so forth in moving and operating the mobile printer Pr on the paper P and recording an image.

The recording operation guidance unit 80 can employ various methods for guidance using guidance information. The recording operation guidance unit 80 can use, for example, a method of displaying the preview image Pg in accordance with the position and direction (posture) at which the mobile printer Pr is placed. In this case, the recording operation guidance unit 80 uses the printer state obtaining unit 74, the printer movement information obtaining unit 75, and the preview image generation unit 77 to generate the preview image Pg in accordance with the position and posture of the mobile printer Pr. In addition, in order to have an image corresponding to the preview image Pg on the paper P, the recording operation guidance unit 80 combines guidelines indicating the position and direction for placing the mobile printer Pr on the paper P, with the recording environment image Kg, and displays the combined image on the display DS. The recording operation guidance unit 80 further outputs, for example, voice-guided guidance information.

The unrecorded area detection unit (unrecorded image calculator) 81 is implemented by the CPU 52, the storage unit 72, and so forth, and detects, out of the recording image, a remaining image (unrecorded image) that has not been recorded and output by the mobile printer Pr on the paper P. For example, the unrecorded area detection unit 81 detects an unrecorded image area by deleting, from the entire area of the recording image stored in the storage unit 72, a recording image area that has been transmitted to the mobile printer Pr and recorded. In this case, the storage unit 72 stores a recording image equivalent to one page of the paper P, and the unrecorded area detection unit 81 detects an unrecorded image area by deleting an already-recorded image from a page recording image.

The recording operation guidance unit 80 also performs an operation of notifying the user of the unrecorded area, detected by the unrecorded area detection unit 81, out of the recording image. Various methods can be employed to notify the user of the unrecorded area. For example, in the case of notifying the user by displaying on the display DS of the UI 62, the recording operation guidance unit 80 notifies the user by displaying the preview image Pg while deleting an image in the unrecorded portion, or conversely displaying an image in the unrecorded portion while deleting the already-recorded image. In the case of voice-guided notification, the recording operation guidance unit 80 outputs, for example, the voice message “Please move the mobile printer Pr in XX direction” from a loudspeaker of the UI 62 in order to guide the user in moving and operating the mobile printer Pr to the unrecorded area. The recording operation guidance unit 80 notifies the user by, for example, slowing down the timing at which sound, such as “pi, pi, pi”, is output when the mobile printer Pr is moved away from the unrecorded area, and speeding up the timing when the movement direction is correct.

Alternatively, in the recording operation guidance unit 80, a unit that outputs information may be provided in the mobile printer Pr. For example, in the recording operation guidance unit 80, the output unit may be provided as a light-emitting diode (LED), for example, at each of the four corners of the top face of the mobile printer Pr. In this case, the recording operation guidance unit 80 may turn on or blink on and off the LED in a direction of the unrecorded area, or, in the case where the LEDs can display arrows, the recording operation guidance unit 80 displays the arrows toward a direction of the unrecorded area. Alternatively, in the recording operation guidance unit 80, the output unit may be provided as a mechanism that controls the operation of the movement assisting mechanism, such as ball feet of the mobile printer Pr. In this case, the recording operation guidance unit 80 controls the movement assisting mechanism, thereby allowing smooth movement when the mobile printer Pr is moved to the unrecorded area, and applying resistance load when the mobile printer Pr is moved in directions other than the direction of the unrecorded area.

Further, in response to completion of recording and outputting of all recording images, the recording operation guidance unit 80 notifies the user that the recording is completed by using display or audio, for example.

Next, the operation according to the embodiment will be described. The image recording system 1 according to the embodiment improves the image quality while improving the operability in manually moving the mobile printer Pr on the recording surface of the paper P and recording an image.

As illustrated in FIG. 1, while manually moving the mobile printer Pr on the paper P, which is a to-be-recorded medium, the image recording system 1 records, by using the mobile printer Pr, a recording image, sent from the mobile information processing terminal KT to the mobile printer Pr, on the recording surface of the paper P.

At this time, in order to accurately record the recording image at a recording position on the paper P at which the user wants to record the image, the user needs to accurately place the mobile printer Pr at the arrangement position on the paper P and to move the mobile printer Pr in an accurate movement direction.

To this end, the image recording system 1 according to the embodiment obtains the relative position of the mobile printer Pr on the paper P and the posture state of the mobile printer Pr, and guides movement of the mobile printer Pr on the basis of these items of information, image data of the recording image, and setting information in recording the recording image.

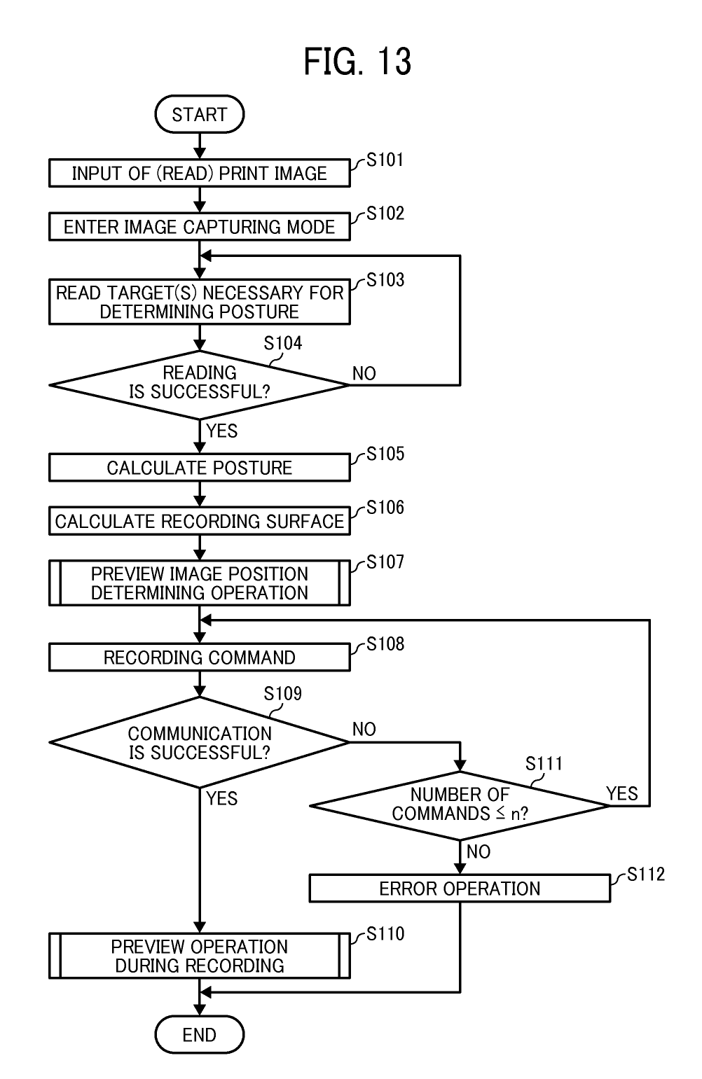

First, an image recording operation of the mobile information processing terminal KT will be described referring to FIG. 13. As illustrated in FIG. 13, in response to an input of a recording image to be recorded (step S101), the mobile information processing terminal KT enters an image capturing mode of capturing an image by the image capturing unit 76 (step S102). An input of a recording image to the mobile information processing terminal KT is performed by, for example, an input of a recording image generated by an installed application or an external device, through a network or a recording medium. If an input of the recording image fails, the mobile information processing terminal KT ends the image recording operation.

In response to entering the image capturing mode, the mobile information processing terminal KT captures an image of the recording environment where the mobile printer Pr is placed on the paper P, thereby obtaining a recording environment image Kg, and stores the recording environment image Kg in the storage unit 72.

In the mobile information processing terminal KT, the printer state obtaining unit 74 analyzes the recording environment image Kg, and extracts (reads) target portions Tg necessary for determining the relative position with respect to the paper P and the posture of the mobile printer Pr (step S103).

The printer state obtaining unit 74 checks whether reading of the target portions Tg is successful (step S104).

When reading of the target portions Tg fails in step S104 (NO in step S104), the printer state obtaining unit 74 returns to step S103, and re-reads the target portions Tg (steps S103 and S104).

When reading of the target portions Tg is successful in step S104 (YES in step S104), the printer state obtaining unit 74 calculates the relative position with respect to the paper P and posture information on the mobile printer Pr (step S105).

The printer state obtaining unit 74 calculates the recording surface of the paper P from the relative distance between each of the target portions Tg and the paper P (step S106).

In the mobile information processing terminal KT, the preview image generation unit 77 generates a preview image from the recording image and setting information in the storage unit 72, and performs a preview image position determining operation of determining the position at which the preview image is to be rendered in the recording environment image Kg (step S107). The preview image position determining operation will be described in detail later.

Having determined the preview image position, the mobile information processing terminal KT transmits a recording command from the communication unit 71 to the mobile printer Pr (step S108), and checks whether communication is successful (step S109).

When communication is successful in step 5109 (YES in step S109), the mobile information processing terminal KT transmits the recording image to the mobile printer Pr, and causes the mobile printer Pr to record the recording image. Also, the mobile information processing terminal KT checks the position and posture of the mobile printer Pr, and performs a during-recording preview operation of displaying a preview image Pg during recording. If recording of all recording images is completed, the mobile information processing terminal KT ends the image recording operation (step S110).

When communication fails in step S109 (NO in step S 109), the mobile information processing terminal KT counts the number of recording commands, and checks whether the number of recording commands is less than or equal to a preset certain number n (step S111).

When the number of recording commands is less than or equal to the certain number n in step 5111 (YES in step S111), the mobile information processing terminal KT returns to step 5108, and performs the operation as above, starting from transmission of a recording command (steps S108, S109, and S111).

When the number of recording commands exceeds the certain number n in step S111 (NO in step S111), the mobile information processing terminal KT performs an error operation, and ends the image recording operation (step S112). The error operation is, for example, an operation of displaying that there is a communication error on the display DS of the UI 62.

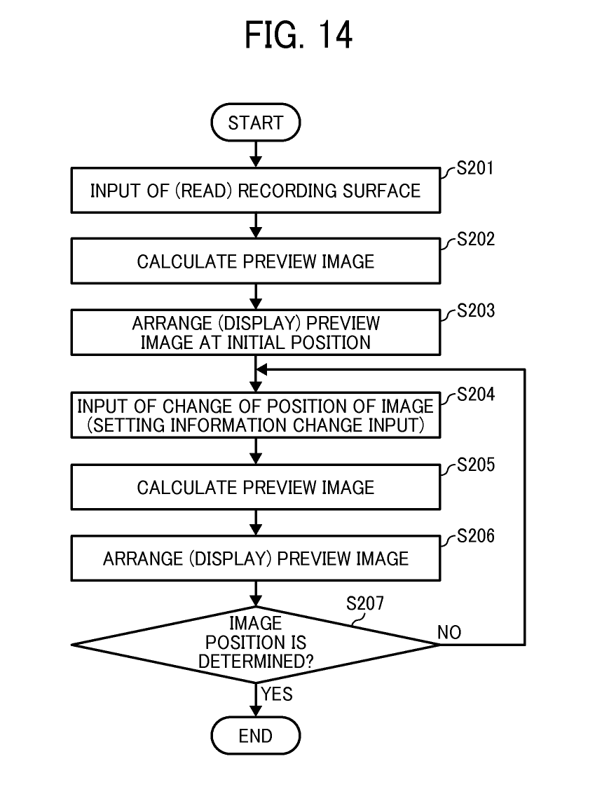

The mobile information processing terminal KT executes the preview image position determining operation in step S107 described above, as illustrated in FIG. 14.

First, in the mobile information processing terminal KT, the printer state obtaining unit 74 extracts a video image of the target portions Tg, and detects the recording surface of the paper P from the video image of the target portions Tg and a previously known casing size of the mobile printer Pr (step S201).

Next, the preview image generation unit 77 generates a preview image to be displayed on the display DS, from the recording image and the setting information, and further adjusts the preview image to the position and size of the detected recording surface of the paper P (step S202).

The preview image generation unit 77 displays the generated preview image at an initial position based on the setting information, on the recording surface of the paper P displayed on the display unit 82 (step S203).

Next, the setting information change obtaining unit 79 obtains a change of the setting information, that is, an input of a change of the position, size, angle, or scale of the recording image (step S204).

The preview image generation unit 77 re-generates the preview image in accordance with the recording surface of the paper P in the recording environment image Kg, on the basis of the changed setting information, a change of which has been obtained by the setting information change obtaining unit 79 (step S205). The preview image generation unit 77 displays the re-generated preview image on the display unit 82 (step S206).

Next, the mobile information processing terminal KT determines whether the image position has been determined by determining, for example, whether an “image position determination” key displayed by the display unit 82 has been touched and operated (step S207).

When the image position has not been determined in step S207 (NO in step S207), the mobile information processing terminal KT returns to step S204, and performs the operation as above (steps S204 to S207).

When the image position has been determined in step S207 (YES in step S207), the mobile information processing terminal KT ends the preview image position determining operation.

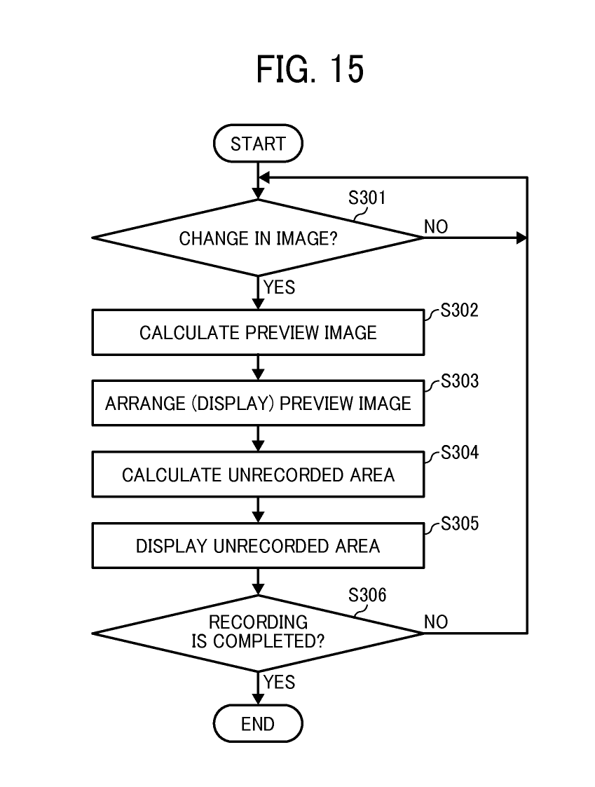

Also, the mobile information processing terminal KT executes the preview operation during recording in step S110 in FIG. 13, as illustrated in FIG. 15. Although the mobile information processing terminal KT automatically starts the preview operation during recording in response to normal reception by the mobile printer Pr of a recording command, as described above, the user may be allowed to select whether to perform the preview operation during recording. In this way, after the user gives a recording command with the mobile information processing terminal KT, the user may leave the mobile information processing terminal KT and may be engaged solely in operating the mobile printer Pr. In such a case, the user may not see the preview image Pg displayed on the display DS of the mobile information processing terminal KT. In doing so, usability can be ensured, while reducing power consumption.

In the preview operation during recording, the mobile information processing terminal KT first checks whether there is a change in an image displayed by the display unit 82, as illustrated in FIG. 15 (step S301). That is, the mobile information processing terminal KT checks whether there is a change in the recording environment image Kg combined with the preview image, a guidance image of recording operation guidance information being displayed, an image for notification of an unrecorded area, and particularly in the preview image itself.

When the mobile information processing terminal KT determines that there is a change in an image in step S301 (YES in step S301), the preview image generation unit 77 re-generates a preview image (step S302).

The mobile information processing terminal KT combines the preview image generated by the preview image generation unit 77 with the recording environment image Kg, and displays the combined image on the display unit 82 (step S303).

Next in the mobile information processing terminal KT, the unrecorded area detection unit 81 calculates an unrecorded image area out of the recording image (step S304), and the recording operation guidance unit 80 combines the unrecorded image area with the preview image, and displays the combined image on the display unit 82 (step S305).

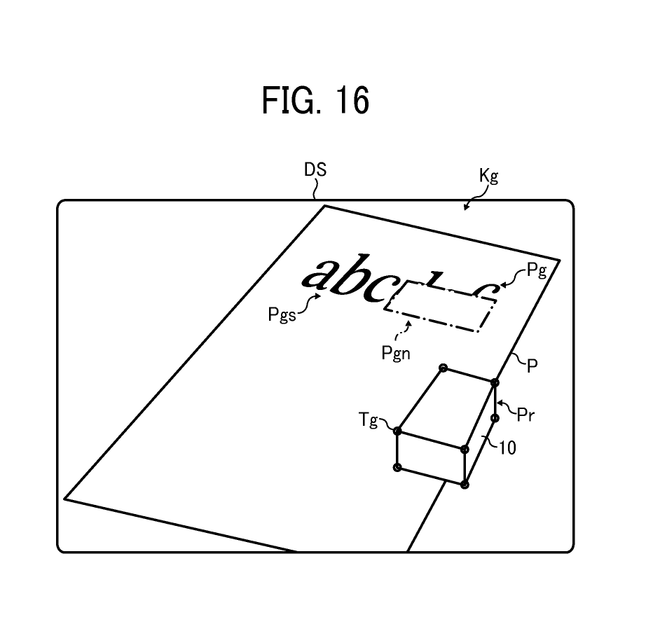

In displaying the unrecorded image area, as illustrated in FIG. 16, the recording operation guidance unit 80 displays only a recorded image area Pgs as a preview image Pg, and displays an unrecorded image area Pgn using a mark having an arbitrary shape, as indicated by a broken line in FIG. 16. Note that FIG. 16 illustrates the case in which the preview image calculating operation in step S302 in FIG. 15 and the preview image displaying operation are not executed. Referring to FIG. 16, in the case of performing the preview image calculating operation and the preview image displaying operation, the preview image Pg is also displayed in the unrecorded image area Pgn. In addition, referring to FIG. 16, the recording operation guidance unit 80 may emphasize the display of the unrecorded image area Pgn by, for example, causing the mark indicating the unrecorded image area Pgn to blink on and off

After displaying the unrecorded area, the mobile information processing terminal KT checks whether recording of all recording images is completed (step S306).

When recording of all recording images is not completed in step S306 (NO in step S306), the mobile information processing terminal KT returns to step S301, and performs the operation as above (steps S301 to S306).

When recording of all recording images is completed in step S306, the preview operation during recording ends.

Note that the above-described preview operation during recording is not necessarily required in a recording management operation according to an embodiment of the present invention, and only print end determination may be performed.

That is, after the user sends a recording command from the mobile information processing terminal KT, the user may leave the mobile information processing terminal KT, hold the mobile printer Pr in his/her hand, and move the mobile printer Pr on the paper P. In such a case, it is difficult for the user to check the preview display during recording. Therefore, the user may be allowed to select whether to perform the preview operation during recording.

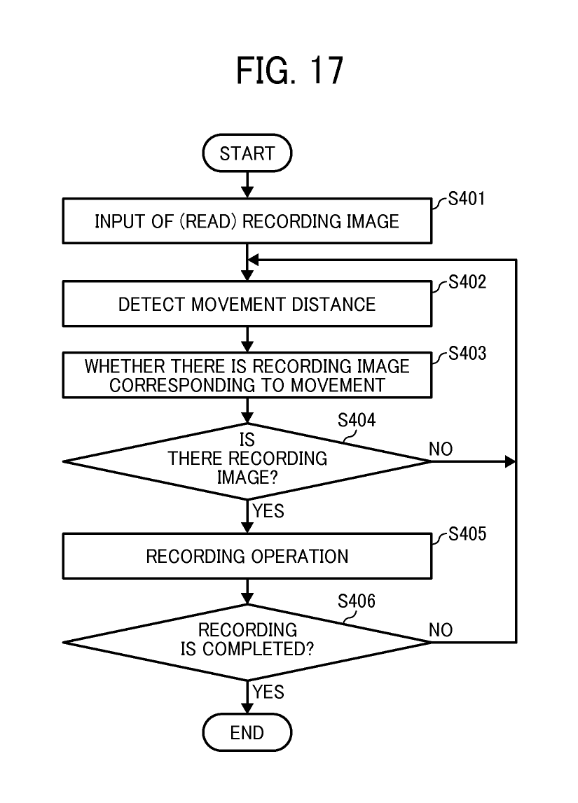

In the image recording system 1, an image recording operation of the mobile printer Pr is executed as illustrated in FIG. 17.

That is, in response to reception by the communication unit 41 (of an input) of a recording image from the mobile information processing terminal KT (step S401), the mobile printer Pr stores the recording image once in the storage unit 42.

Next in the mobile printer Pr, the movement state detection unit 45 detects the amount of movement (movement distance) of the mobile printer Pr (step S402).

The recording control unit 44 checks a recording image corresponding to the amount of movement (step S403), and checks whether there is a recording image (step S404).

When there is no recording image in step S404 (NO in step S404), the mobile printer Pr returns to step S402, and performs the operation as above, starting from detection of the amount of movement of the mobile printer Pr (steps S402 to S404).

When there is a recording image in step S404 (YES in step S404), the recording control unit 44 controls the operation of the recording unit 43, and causes the recording unit 43 to record an image of the recording image on the paper P (step S405).

After the mobile printer Pr records an image of the recording image corresponding to the movement, the recording control unit 44 checks whether recording of all recording images is completed (step S406). The recording control unit 44 checks this recording completion by, for example, determining whether a recording end command has been received from the mobile information processing terminal KT.

When recording of all recording images is not completed in step S406 (NO in step S406), the mobile printer Pr returns to step S402, and performs the operation as above (steps S402 to S406).

When recording of all recording images is completed in step S406 (YES in step S406), the mobile printer Pr ends the image recording operation.

Although the case in which the image recording system 1 according to the embodiment includes the mobile printer Pr and the mobile information processing terminal KT has been described, the configuration of the image recording system 1 is not limited to this case. For example, the image recording system 1 may include the mobile printer Pr, a desktop computer, and a camera that can output an image to the desktop computer. In this case, the camera captures a recording environment image of the paper P and the mobile printer Pr, and outputs the recording environment image to the desktop computer. The desktop computer executes functions other than the image capturer 61 of the mobile information processing terminal KT according to the embodiment.

As described above, the image recording system 1 according to the embodiment includes the mobile printer (image recording device) Pr including an image recorder that records an image on paper (to-be-recorded medium) P on the basis of image data and setting information for recording and outputting using the image data, the mobile printer Pr being moved and operated on the paper P; an image recording device state obtaining unit including the image capturing unit 76 and the printer state obtaining unit 74, which obtains the relative position and posture state of the mobile printer Pr with respect to the paper P; the guidance information calculation unit (guidance information calculator) 78 which calculates recording operation guidance information including the arrangement position of the mobile printer Pr with respect to the paper P, and the movement operation direction of the mobile printer Pr, at least in order for the mobile printer Pr to record the image on the paper P, on the basis of the image data, the setting information, the relative position, and the posture state; a recording control including the recording control unit 44 and the recording image editing unit 73, which causes the mobile printer Pr to record the image in accordance with the image data, the setting information, the relative position, and the posture state, on the paper P; and a reporter including the recording operation guidance unit 80 and the display unit 82, which reports and outputs the recording operation guidance information.

Therefore, in recording an image by placing the mobile printer Pr, which is an image recording device, on the paper P and moving and operating the mobile printer Pr, the position at which the mobile printer Pr is placed and the movement operation direction can be guided, and an image in accordance with the position of the mobile printer Pr can be recorded and output. As a result, while the operability in manually moving the mobile printer Pr and recording an image is improved, the image quality can be improved.

In addition in the image recording system 1 according to the embodiment, the image recording device state obtaining unit captures an image of at least the mobile printer Pr and the paper P as a recording environment image Kg, and obtains the relative position and the posture state from the captured image. The guidance information calculation unit 78, which serves as the guidance information calculator, calculates the recording operation guidance information as a recording operation guidance image on the recording environment image Kg. The reporter includes a display (display) DS that displays an image. The reporter superimposes the recording operation guidance image on the recording environment image Kg and displays the combined image on the display DS.

Therefore, the recording operation guidance information can be displayed as a recording operation guidance image on the recording environment image Kg, and, while the operability in manually moving the mobile printer Pr and recording an image is further improved, the image quality can be improved.

Further, in the image recording system 1 according to the embodiment, the mobile printer Pr is provided with a plurality of target portions (marks) Tg at a plurality of places for recognizing the shape of the mobile printer Pr. The image recording device state obtaining unit extracts the target portions Tg from a captured image of the mobile printer Pr, and obtains the relative position and the posture state from the target portions Tg.

Therefore, the relative position and the posture state can be easily and accurately obtained from a captured image of the mobile printer Pr by using the target portions Tg, and the operability and the image quality in manually moving the mobile printer Pr and recording an image can be improved at low cost.

The image recording system 1 according to the embodiment further includes the preview image generation unit (preview generator) 77 which generates a preview image Pg of the image data on the basis of the image data and the setting information, and the display unit (display control) 82 which displays the preview image Pg on the display DS.

Therefore, the image recording operation can be performed while checking the recording image, and hence the usability can be improved.

The image recording system 1 according to the present embodiment further includes the preview image generation unit (preview image adjuster) 77 which adjusts the preview image to an image of the paper P included in the recording environment image Kg. The display unit (display control) 82 superimposes the adjusted preview image Pg on an image of the paper P included in the recording environment image Kg and displays the combined image on the display DS.

Therefore, the preview image Pg can be displayed in a state where the recording image is actually recorded on the paper P displayed on the display DS. In doing so, the image recording operation can be performed while checking the recording image in a more accurate state, and the usability can be further improved.

The image recording system 1 according to the embodiment further includes the setting information change obtaining unit (setting information change acceptor) 79 which accepts a change of the setting information, and the setting information change obtaining unit (change control) 79 which causes, on the basis of the changed setting information, the guidance information calculation unit (guidance information calculator) 78 to re-calculate the recording operation guidance information, causes the guidance information calculation unit (guidance information calculator) 78 to re-calculate the recording operation guidance information, and the preview image generation unit (preview generator) 77 to re-generate the preview image Pg, or causes the guidance information calculation unit (guidance information calculator) 78 to re-calculate the recording operation guidance information, the preview image generation unit (preview generator) 77 to re-generate the preview image Pg, and the preview image generation unit (preview image adjuster) 77 to adjust the preview image to the paper P in the recording environment image Kg.

Therefore, in recording an image or during recording, the setting information can be arbitrarily changed, and the recording operation guidance information and the preview image 3 0 can be re-generated in accordance with a change in the setting information. As a result, the usability can be further improved.

Further in the image recording system 1 according to the embodiment, the reporter includes a display (display) DS that displays at least the preview image Pg, and the display unit (touch operation detector) 82 which detects a touch operation performed on an image displayed on the display DS. The setting information change obtaining unit (setting information change acceptor) 79 obtains, as a change of the setting information, a touch operation, detected by the display unit 82 serving as the touch operation detector, of giving an instruction to change the preview image Pg displayed on the display DS.

Therefore, the setting information in recording an image or the setting information during recording can be changed by a touch operation on the preview image Pg, and the usability can be further improved.

The image recording system 1 according to the embodiment further includes a movement state obtaining unit including the printer movement information obtaining unit 75 and the movement state detection unit 45, which obtains the movement state of the mobile printer Pr. The guidance information calculation unit (guidance information calculator) 78 calculates the movement operation direction of the mobile printer Pr from the current position of the mobile printer Pr, obtained by the movement state obtaining unit.

Therefore, even when the mobile printer Pr is manually moved and operated to record an image, an appropriate movement operation direction can be made recognizable, and the operability and the image quality in manually moving the mobile printer Pr and recording an image can be further improved.

The image recording system 1 according to the embodiment further includes the unrecorded area detection unit (unrecorded image calculator) 81 which calculates an unrecorded image out of the image based on the image data. The guidance information calculation unit (guidance information calculator) 78 calculates, on the basis of the unrecorded image, recording operation guidance information for guiding the movement operation direction of the mobile printer Pr from the current position of the mobile printer Pr, obtained by the movement state obtaining unit, to a direction of the unrecorded image.

Therefore, even when the mobile printer Pr is manually moved and operated to record an image, the mobile printer Pr can be guided to a direction of the unrecorded image, and the operability and the image quality in manually moving the mobile printer Pr and recording an image can be further improved.

In the image recording system 1 according to the embodiment, the mobile information processing terminal KT and the mobile printer Pr, which serves as the image recording device, are connected wirelessly or by wire, and the mobile information processing terminal KT and the mobile printer Pr have the above-described elements in an appropriate and sharing manner.

Therefore, the recording image can be recorded while the mobile information processing terminal KT checks the position where the mobile printer Pr is placed and the movement direction of the mobile printer Pr, and the operability and the image quality in manually moving the mobile printer Pr and recording an image can be improved.

The image recording system 1 according to the embodiment executes an image recording method including an image recording device state obtaining step of obtaining the relative position and posture state of the mobile printer Pr, moved and operated on paper (to-be-recorded medium) P, with respect to the paper P, the mobile printer Pr including an image recorder that records an image on the paper P on the basis of image data and setting information for recording and outputting using the image data; a guidance information calculating step of calculating recording operation guidance information including the arrangement position of the mobile printer Pr with respect to the paper P, and the movement operation direction of the mobile printer Pr, at least in order for the mobile printer Pr to record the image on the paper P, on the basis of the image data, the setting information, the relative position, and the posture state; a recording controlling step of causing the mobile printer Pr to record, on the paper P, the image in accordance with the image data, the setting information, the relative position, and the posture state; and a reporting step of reporting and outputting the recording operation guidance information.

Therefore, in recording an image by placing the mobile printer Pr, which is an image recording device, on the paper P and moving and operating the mobile printer Pr, the position at which the mobile printer is placed and the movement operation direction can be guided, and an image in accordance with the position of the mobile printer Pr can be recorded and output. As a result, while the operability in manually moving the mobile printer Pr and recording an image is improved, the image quality can be improved.

Although the present invention made by the inventor of the present invention has been specifically described on the basis of the preferred exemplary embodiment as above, the present invention is not limited to those described in the above embodiment, and needless to say, various changes can be made without departing from the scope thereof.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

1. An image recording system comprising:
an image recording device that records an image on a to-be-recorded medium while being moved on a surface of the to-be-recorded medium;
an information processing device communicable with the image recording device, comprising circuitry that
obtains a relative position and a posture of the image recording device with respect to the to-be-recorded medium;
generates recording operation guidance information that guides the image recording device to record the image on the to-be-recorded medium based on image data, setting information for the image data, and the relative position and the posture of the image recording device, the recording operation guidance information indicating an arrangement position of the image recording device with respect to the to-be-recorded medium and a movement direction of the image recording device; and
outputs the recording operation guidance information; and
controls recording operation of the image recording device based on the image data, the setting information, and the relative position and the posture of the image recording device.

2. The image recording system of claim 1,
wherein the information processing device obtains a captured image of at least the image recording device and the to-be-recorded medium as a recording environment image, the relative position and the posture of the image recording device being calculated from the captured image,
generates the recording operation guidance information as a recording operation guidance image, and
outputs, through a display, an image including the recording operation guidance image superimposed on the recording environment image.

3. The image recording system of claim 2,
wherein the image recording device is provided with a plurality of marks at a plurality of places, and
the information processing device extracts the marks from the captured image of the image recording device, and obtains the relative position and the posture from the marks.

4. The image recording system of claim 2,
wherein the information processing device generates a preview image of the image data to be recorded based on the image data and the setting information; and
outputs, through the display, the preview image together with the image including the recording operation guidance image superimposed on the recording environment image.

5. The image recording system of claim 4,
wherein the information processing device adjusts the preview image according to the to-be-recorded medium included in the recording environment image, and superimposes the adjusted preview image on an image of the to-be-recorded medium included in the recording environment image.

6. The image recording system of claim 4, wherein, when the information processing device receives a user instruction for changing the setting information, the information processing device re-generates recording operation guidance information and a preview image based on the changed setting information.

7. The image recording system of claim 6, wherein the information processing device includes:
the display that displays at least the preview image; and
a touch sector that detects a touch operation on the preview image, as the user instruction for changing the setting information.

8. The image recording system of claim 1,
wherein the information processing device receives a movement detection result of the image recording device from a sensor, and calculates the movement direction of the image recording device from a current position of the image recording device, the current position being obtained based on the movement detection result.

9. The image recording system of claim 8,
wherein the information processing device determines whether there is an unrecorded image out of the image based on the image data,
and, when there is the unrecorded image, generates recording operation guidance information that guides a movement direction of the image recording device from the current position of the image recording device to a location of the unrecorded image.

10. An information processing device communicable with an image recording device configured to record an image on a to-be-recording medium, while being moved on a surface of the to-be-recorded medium, the information processing device comprising a circuitry that
obtains a relative position and a posture of the image recording device with respect to the to-be-recorded medium;
generates recording operation guidance information that guides the image recording device to record the image on the to-be-recorded medium based on image data, setting information for the image data, and the relative position and the posture of the image recording device, the recording operation guidance information indicating an arrangement position of the image recording device with respect to the to-be-recorded medium and a movement direction of the image recording device;
outputs the recording operation guidance information; and
controls recording operation of the image recording device based on the image data, the setting information, and the relative position and the posture of the image recording device.

11. A method of controlling image recording, comprising:
obtaining a relative position and a posture of an image recording device with respect to a to-be-recorded medium, the image recording device to record an image on the to-be-recorded medium while being moved on a surface of the to-be-recorded medium;
generating recording operation guidance information that guides the image recording device to record the image on the to-be-recorded medium based on image data, setting information for the image data, and the relative position and the posture of the image recording device, the recording operation guidance information indicating an arrangement position of the image recording device with respect to the to-be-recorded medium and a movement direction of the image recording device;
outputting the recording operation guidance information; and
controlling recording operation of the image recording device based on the image data, the setting information, and the relative position and the posture of the image recording device.
